(19) United States
(12) Patent Application Publication
(10) Pub. No.: US 2022/0149457 A1
(43) Pub. Date: May 12, 2022

(54) BATTERY, BATTERY PACK, ELECTRONIC DEVICE, ELECTRIC VEHICLE, POWER STORAGE APPARATUS, AND POWER SYSTEM

(71) Applicant: MURATA MANUFACTURING CO., LTD., Kyoto (JP)

(72) Inventor: Hideyasu TAKATSUJI, Kyoto (JP)

(21) Appl. No.: 17/579,166

(22) Filed: Jan. 19, 2022

Related U.S. Application Data
(63) Continuation of application No. PCT/JP2020/026968, filed on Jul. 10, 2020.

(30) Foreign Application Priority Data
Jul. 19, 2019 (JP) 2019-133573

(51) Int. Cl. H01M 10/658

(52) U.S. Cl. CPC H01M 10/658; H01M 2220/20

(57) ABSTRACT

A battery includes an electrode body and an exterior member that accommodates the electrode body. At least a part of the exterior member is covered with an insulating member, and the insulating member has a multi-layer structure. A side of the insulating member in contact with the exterior member is defined as an inner layer and a side of the insulating member opposite to the inner layer is defined as an outer layer. An innermost layer of the insulating member includes a nonflammable gas generating member that generates nonflammable gas at high temperature, and an outermost layer of the insulating member includes an insulating resin layer.

### CROSS REFERENCE TO RELATED APPLICATIONS

The present application is a continuation of PCT patent application no. PCT/JP2020/026968, filed on Jul. 10, 2020, which claims priority to Japanese patent application no. JP2019-133573 filed on Jul. 19, 2019, the entire contents of which are being incorporated herein by reference.

### BACKGROUND

The present disclosure generally relates to, for example, a battery, a battery pack, an electronic device, an electric vehicle, a power storage apparatus, and a power system applied to a lithium ion secondary battery.

In recent years, the use of secondary batteries such as lithium ion batteries has rapidly expanded in, for example, solar cells, power storage apparatuses for power storage, combined with new energy systems such as wind power generation, and automobile storage batteries. In order to use the secondary battery for these applications, a battery pack is used in which a plurality of unit batteries (also referred to as a unit cell or a cell, and simply referred to as a battery as appropriate in the following description) are connected in series or in parallel.

In the case of a lithium ion secondary battery, there is a risk of abnormal heat generation due to overcharging, overdischarging, or the like, generation of flammable gas, and ignition of the battery.

### SUMMARY

The present disclosure generally relates to, for example, a battery, a battery pack, an electronic device, an electric vehicle, a power storage apparatus, and a power system applied to a lithium ion secondary battery.

In one type of conventional battery technology, a member in the form of a filling material is provided in a battery pack, and when there is uneven filling or air bubbles are mixed in such a filling material, a portion not in contact with the battery cell may exist in the battery pack, and as a result, the damage prevention does not effectively function in some cases. Also, depending on what is used for the filling member, if the strength is insufficient, the battery cannot be held more firmly. Further, in the case of a non-insulated member, the insulation between the batteries cannot be maintained, and a leak current may flow between cases. Moreover, since a heat-insulating material is used, it is not possible to dissipate heat during normal use. It is therefore assumed that heat will be trapped inside the pack and the usage time with a large current will be limited.

In another type of conventional battery technology, a battery has a sheet packed with a filler, and the sheet is attached to a part of the battery cell in the side surface and the top surface or the like of the battery. When any of the batteries ignites, a flame or high temperature gas will irregularly convect in the pack, which brings a healthy battery cell into a state of being damaged from any portion. As a result, the battery cannot be effectively protected. Further, various contents can be enclosed by packing the filler in the form of a sheet, but heat transfer is poor because the heat is passed through the outer sheet of the bag. Moreover, if the production process includes quality control, there is a problem that the production process becomes complicated and the cost becomes high.

Therefore, an object of the present disclosure is to provide a battery, a battery pack, an electronic device, an electric vehicle, a power storage apparatus, and a power system capable of solving these problems.

The present disclosure provides a battery according to an embodiment including:

an electrode body; and

an exterior member that accommodates the electrode body,

at least a part of the exterior member is covered with an insulating member, and the insulating member has a multi-layer structure,

a side of the insulating member in contact with the exterior member is defined as an inner layer and a side of the insulating member opposite to the inner layer is defined an outer layer, and an innermost layer of the insulating member includes a nonflammable gas generating member that generates nonflammable gas at high temperature, and an outermost layer of the insulating member includes an insulating resin layer.

It is possible to achieve both a function of insulating the battery and a function of effectively generating nonflammable gas.

Further, the present disclosure provides a battery pack according to an embodiment including a plurality of the batteries accommodated in a case with an inter-cell holding member interposed between the plurality of the batteries.

The inter-cell holding member includes a member that generates nonflammable gas at high temperature and is formed as a foam.

By using a material that generates nonflammable gas at high temperature and does not easily conduct heat for the insulating member used for the purpose of insulating the outer case of the battery cell, nonflammable gas is generated through thermal decomposition when one of the batteries generates heat in the battery pack and the temperature thereof rises. The nonflammable gas enables reduction in the oxygen concentration in the pack, and the effect of smothering fire extinguishing can be expected.

Further, when the battery ignites, nonflammable gas is generated from the insulating member of the adjacent battery, so that the ignition of the next battery can be stopped.

Further, the present disclosure provides a battery pack according to an embodiment including:

the plurality of the batteries;

an outer case that accommodates the plurality of the batteries; and

an inter-cell holding member that holds the plurality of the batteries, wherein the inter-cell holding member includes a foamed resin and further contains a substance that generates nonflammable gas at a high temperature.

In the present disclosure, by holding the top and bottom of the battery with a strong holding member, a battery pack resistant to vibration, drop impact, and the like can be obtained, and the heat of the battery whose temperature has risen in normal high load operation can be dissipated to the case via the holding member.

The present disclosure provides an electronic device according to an embodiment that receives power supplied from the battery.

The present disclosure provides an electric vehicle according to an embodiment including: the battery; a conversion apparatus that receives power supplied from the battery and converts the power into a driving force of the electric vehicle; and a processor configured to process information related to vehicle control based on information about the battery.

The present disclosure provides a power storage apparatus according to an embodiment including the battery. The power storage apparatus is configured to supply power to an electronic device connected to the battery.

The present disclosure provides a power system according to an embodiment that receives power supplied from the battery.

According to at least an embodiment, it is possible to provide a safe battery pack that does not cause fire spreading to another battery when one battery ignites. The effects described here are not necessarily limited, and may be any of the effects described in the present specification or an effect different from them.

### BRIEF DESCRIPTION OF THE FIGURES

FIG. 1 is a sectional view of an example of a lithium ion secondary battery according to an embodiment of the present disclosure.

FIG. 2 is a perspective view according to an embodiment of the present disclosure.

FIGS. 3A and 3B are a perspective view and an enlarged sectional view used for explaining an insulating member according to an embodiment of the present disclosure.

FIG. 4 is an enlarged sectional view according to an embodiment of the present disclosure.

FIG. 5 is a perspective view used for explaining an example of the insulating member according to an embodiment of the present disclosure.

FIG. 6 is a perspective view used for explaining an example of the insulating member according to an embodiment of the present disclosure.

FIGS. 7A and 7B are perspective views used for explaining an example of the insulating member according to an embodiment of the present disclosure.

FIG. 8 is a perspective view used for explaining an embodiment in which the present disclosure is applied to a battery pack.

FIG. 9 is a perspective view of an inter-cell foam holding member according to an embodiment of the present disclosure.

FIG. 10 is a perspective view used for explaining an embodiment in which the present disclosure is applied to a battery pack.

FIGS. 11A and 11B are perspective views used for explaining an upper holding member and a lower holding member according to an embodiment of the present disclosure.

FIG. 12 is a connection diagram used for explaining a battery pack as an application example according to an embodiment of the present disclosure.

FIG. 13 is a connection diagram used for explaining an electric tool as an application example according to an embodiment of the present disclosure.

FIG. 14 is a connection diagram used for explaining an unmanned aircraft as an application example according to an embodiment of the present disclosure.

FIG. 15 is a front view showing the configuration of an unmanned aircraft according to an embodiment of the present disclosure.

FIGS. 16A and 16B are a schematic diagram used for explaining an example and another example of the configuration of a battery unit according to an embodiment of the present disclosure.

FIG. 17 is a connection diagram used for explaining a power storage system for a house as an application example according to an embodiment of the present disclosure.

FIG. 18 is a connection diagram used for explaining an electric vehicle as an application example according to an embodiment of the present disclosure.

### DETAILED DESCRIPTION

As described herein, the present disclosure will be described based on examples with reference to the drawings, but the present disclosure is not to be considered limited to the examples, and various numerical values and materials in the examples are considered by way of example.

First, the first embodiment of the present disclosure will be described. A battery to which the present disclosure can be applied, for example, a cylindrical lithium ion secondary battery will be described.

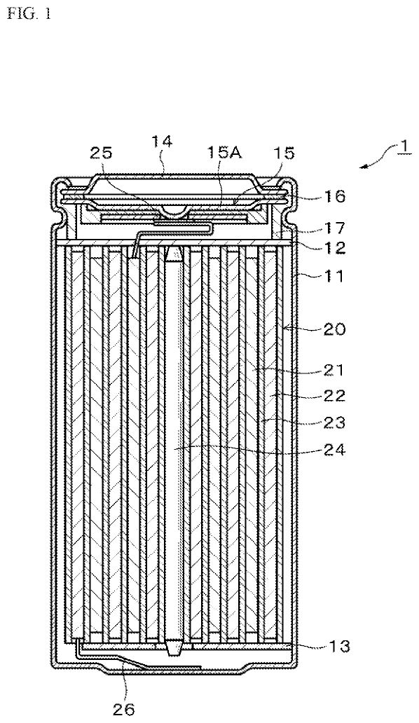

In the first embodiment of the present disclosure, as an example, a cylindrical non-aqueous electrolyte secondary battery (hereinafter, referred to as “non-aqueous electrolyte battery” or simply “battery”) will be described with reference to FIG. 1.

As shown in FIG. 1, this battery 1 mainly includes a wound electrode body 20 and a pair of insulating plates 12 and 13 housed inside a substantially hollow cylindrical battery can 11. A battery structure using such a battery can 11 is called a cylindrical type.

The battery can 11 has, for example, a hollow structure in which one end is closed and the other end is open, and is made of iron (Fe), aluminum (Al), an alloy thereof, or the like. When the battery can 11 is made of iron, for example, the surface of the battery can 11 may be plated with nickel (Ni) or the like. The pair of insulating plates 12 and 13 sandwich the wound electrode body 20 from above and below, and are provided so as to extend perpendicularly to the winding peripheral surface of the wound electrode body 20.

In the open end of the battery can 11, a battery lid 14, a safety valve mechanism 15, and a positive temperature coefficient element (PTC element) 16 are crimped with a gasket 17, and the battery can 11 is sealed. The battery lid 14 is made of, for example, the same material as that of the battery can 11. The safety valve mechanism 15 and the positive temperature coefficient element 16 are provided inside the battery lid 14.

The safety valve mechanism 15 is electrically connected to the battery lid 14 via the positive temperature coefficient element 16. In this safety valve mechanism 15, when the internal pressure exceeds a certain level due to an internal short circuit or heating from the outside, a disk plate 15A is inverted to disconnect the electrical connection between the battery lid 14 and the wound electrode body 20.

The positive temperature coefficient element 16 prevents abnormal heat generation due to a large current by increasing the resistance (limiting the current) as the temperature rises. The gasket 17 is made of, for example, an insulating material, and the surface thereof is coated with, for example, asphalt.

The wound electrode body 20 is formed by laminating and winding a positive electrode 21 and a negative electrode 22 with a separator 23 interposed therebetween. A center pin 24 may be inserted in the center of the wound electrode body 20.

A positive electrode lead 25 is connected to the positive electrode 21 of the wound electrode body 20. A negative electrode lead 26 is connected to the negative electrode 22. The positive electrode lead 25 is welded to the safety valve mechanism 15 and electrically connected to the battery lid 14. The negative electrode lead 26 is welded to the battery can 11 and electrically connected to the battery can 11.

The positive electrode lead 25 is, for example, a thin plate-shaped conductive member, and is made of, for example, aluminum. The negative electrode lead 26 is, for example, a thin plate-shaped conductive member, and is made of copper (Cu), nickel, stainless steel (SUS), or the like.

The positive electrode 21 is, for example, one in which positive electrode active material layers 21B are provided on both sides of a positive electrode current collector 21A.

The positive electrode 21 may have a region in which a positive electrode active material layer 21B is provided on only one side of a positive electrode current collector 21A.

As the positive electrode current collector 21A, for example, a metal foil such as an aluminum foil, a nickel foil, or a stainless steel foil can be used.

The positive electrode active material layer 21B contains a positive electrode active material. The positive electrode active material layer 21B may contain other materials such as a conductive agent and/or a binder according to an embodiment.

The negative electrode 22 has a structure in which negative electrode active material layers 22B are provided on both sides of a negative electrode current collector 22A.

The negative electrode 22 may have a region in which the negative electrode active material layer 22B is provided on only one side of the negative electrode current collector 22A. As the negative electrode current collector 22A, for example, a metal foil such as a copper foil can be used.

The separator 23 separates the positive electrode 21 and the negative electrode 22 and allows lithium ions to pass through while preventing a short circuit of a current due to contact between the two electrodes.

The separator 23 is impregnated with an electrolytic solution, which is a liquid electrolyte. The electrolytic solution is, for example, a non-aqueous electrolytic solution containing an electrolytic salt and a non-aqueous solvent for dissolving the electrolytic salt. The non-aqueous electrolytic solution may contain additives and the like, as necessary.

In the non-aqueous electrolyte battery described above, for example, at the time of charging, lithium ions are released from the positive electrode 21 and are occluded in the negative electrode 22 via the electrolytic solution impregnated in the separator 23. On the other hand, for example, at the time of discharging, lithium ions are released from the negative electrode 22 and are occluded in the positive electrode 21 via the electrolytic solution impregnated in the separator 23.

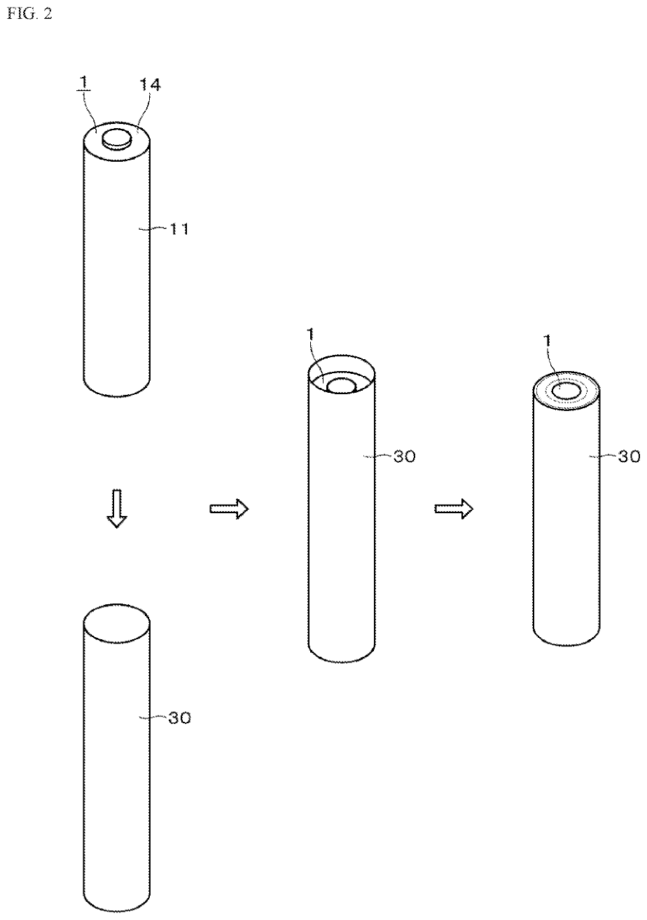

As shown in FIG. 2, the battery 1 is covered with an insulating member (insulating tube) 30 in order to insulate the battery can 11 as the exterior member of a cylindrical lithium ion secondary battery 1 described above. For example, the insulating member 30 is made of a heat-shrinkable material, and the battery 1 is inserted into the insulating member 30 which is formed into a cylindrical shape, and then the insulating member 30 is shrunk by heating to hold the battery 1.

In the first embodiment of the present disclosure, the insulating member 30 contains a non-nonflammable gas generating material that generates nonflammable gas by heating. That is, the insulating member 30 is thermally decomposed when the temperature rises to generate nonflammable gas, thereby making it possible to reduce the oxygen concentration in the pack. Therefore, when the temperature of the battery 1 becomes high, nonflammable gas is generated. This can reduce the oxygen concentration around the battery 1, and thus suppress the ignition of the battery 1. Further, the insulating member 30 allows smothering fire extinguishing when the battery 1 ignites. Further, nonflammable gas is generated from the insulating members provided in the other adjacent batteries, so that spread of the fire to the surrounding batteries can be stopped.

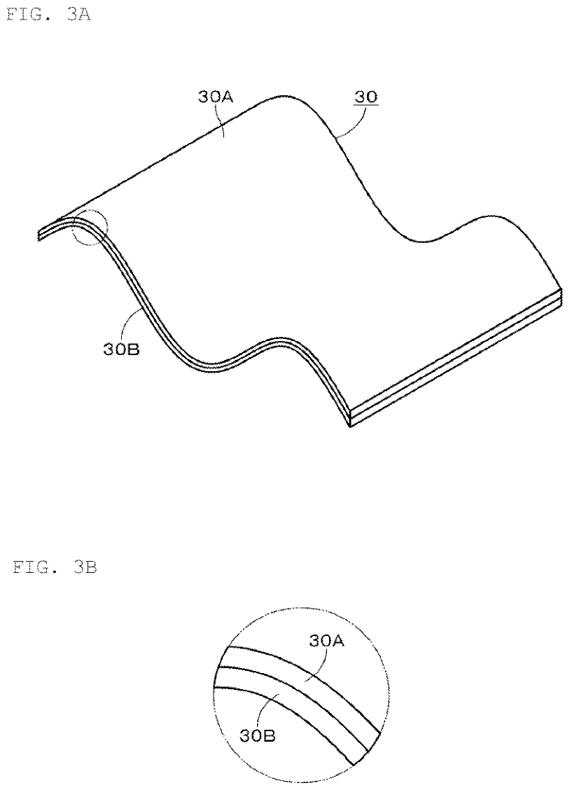

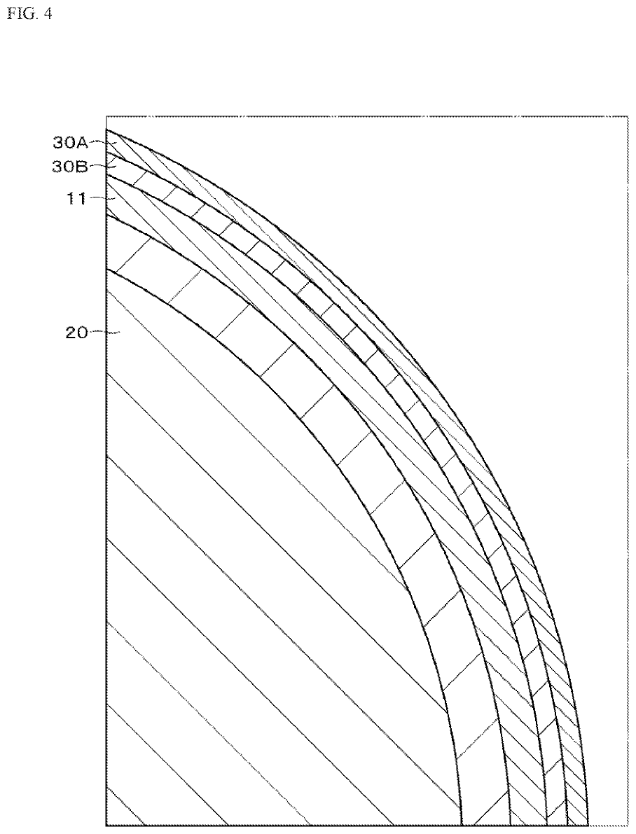

An example of the insulating member 30 is shown in FIG. 3A, and an enlarged sectional view thereof is shown in FIG. 3B. In this example, the insulating member 30 has a two-layer structure of a film-shaped insulating resin layer (insulating sheet) 30A and a nonflammable gas generating member 30B. For example, the insulating member 30 is produced by applying the nonflammable gas generating member 30B to the insulating resin layer 30A and drying it. The nonflammable gas generating member 30B is brought into contact with the battery can 11 which is the exterior member of the battery 1. The insulating resin layer 30A provides an insulating effect of each battery cell, and the nonflammable gas generating member 30B can generate nonflammable gas for ignition prevention and extinguishing. FIG. 4 shows an enlarged transverse section of a part of the battery 1 covered with the insulating member 30.

The following materials can be used as the insulating shrinkage material of the insulating resin layer 30A.

PVC (polyvinyl chloride), PET (polyethylene terephthalate), polyolefin, PTFE (Teflon (registered trademark)), and silicone

The nonflammable gas generated from the nonflammable gas generating member 30B is as follows.

H₂O, CO, CO₂, N₂, NO, NO₂

The nonflammable gas generating member 30B contains a nonflammable gas generating substance, and examples thereof are as follows.

Substances that generate N₂, NO, or NO₂: melamine resin, nitrogen-containing phenolic resin, and nitrogen-containing epoxy resin

Substances that generate CO or CO₂: sodium acetate, potassium acetate, sodium bicarbonate, magnesium bicarbonate, calcium bicarbonate, and potassium bicarbonate

Substances that generate H₂O and have conductivity: magnesium hydroxide, sodium hydroxide, and/or calcium hydroxide

The following materials can be used as a binder used when applying the nonflammable gas generating member 30B.

Polyester resin, polyolefin resin, epoxy resin, phenolic resin, PVA (polyvinyl alcohol), EVA (ethylene/vinyl acetate copolymer resin), PVDF (polyvinylidene fluoride), acrylic, and/or polyurethane. By using the binder as described above, the nonflammable gas generating member 30B can be brought into close contact with the battery exterior member without peeling or the like of nonflammable gas generating member 30B when the insulating member 30 is thermally shrunk.

The first embodiment of the present disclosure described above has the following effects.

Firstly, the heat generated from the inside of the battery that has generated heat at the time of abnormal heat generation is first propagated to the nonflammable gas generating member 30B through the battery can 11. The propagated heat causes the non-combustible gas to be generated through thermal decomposition, thereby reducing the oxygen concentration around the battery that has abnormally generated heat and enabling smothering fire extinguishing.

Secondly, also in the batteries adjacent to the ignited battery, heating by the heat propagated by heat conduction and the ignited flame cause nonflammable gas to be generated around the battery surface, thereby preventing an induced explosion of the next battery.

Thirdly, provision of the insulating member 30 in the battery exterior allows safe handling such that a short circuit does not occur when the battery cell exterior members having a potential come into contact each other during assembly or deformation of the pack.

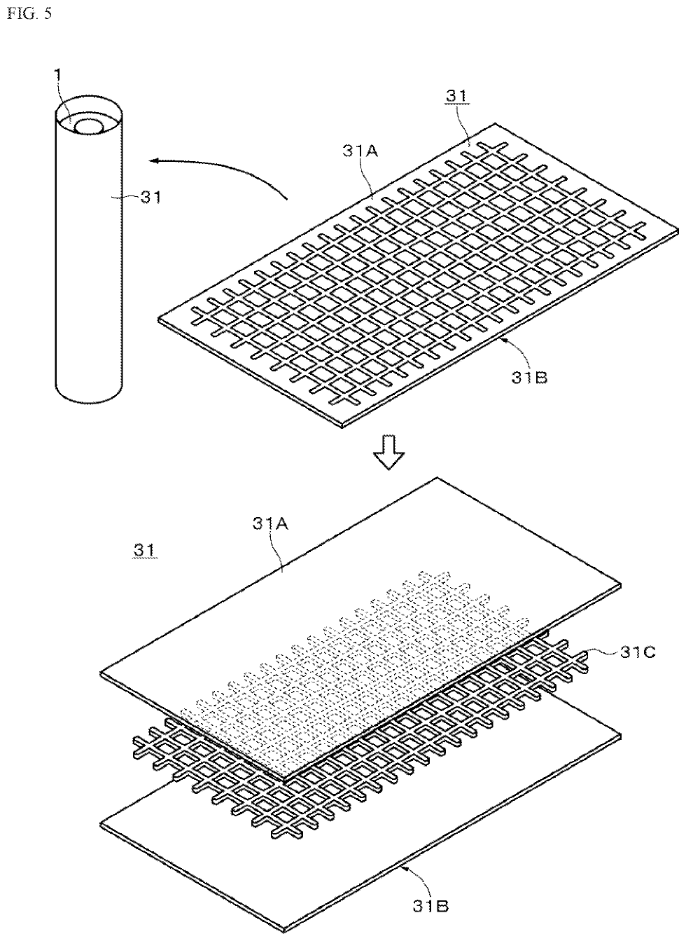

Next, another example of the insulating member (insulating member 31) will be described. As shown in FIG. 5, the insulating member 31 has a two-layer structure in which the outer layer thereof is an insulating resin layer 31A and the inner layer thereof is a nonflammable gas generating member 31B that generates nonflammable gas at high temperature. The insulating member 31 is characterized in that a lattice-shaped frame 31C having a high melting point is included in the insulating resin layer 31A.

That is, the frame 31C, which has been formed into a lattice shape or a stitch mesh shape and formed of a PEEK material, phenolic resin, carbon fiber, or the like having a high melting point, is incorporated into the insulating resin layer 31A. The melting point of materials such as vinyl chloride and PET used as the insulating resin layer 31A is around 100 to 130° C., and the surface temperature of the battery rises to about 300° C. to 500° C. due to self-heating when the battery is in an abnormal state.

Therefore, if the frame 31C is not incorporated, the insulating resin layer 31A may not be able to maintain its shape at an early stage.

However, since the frame 31C made of a material having a melting point higher than that of the material of the insulating resin layer 31A exists, the shape of the insulating resin layer 31A can be maintained. Therefore, when the insulating resin layer 31A of the outer layer is melted, the frame 31C made of a material having a high melting point maintains its shape. Thereby, the nonflammable gas generating member 31B can be stably kept on the surface of the battery in the high temperature range until the battery ignites.

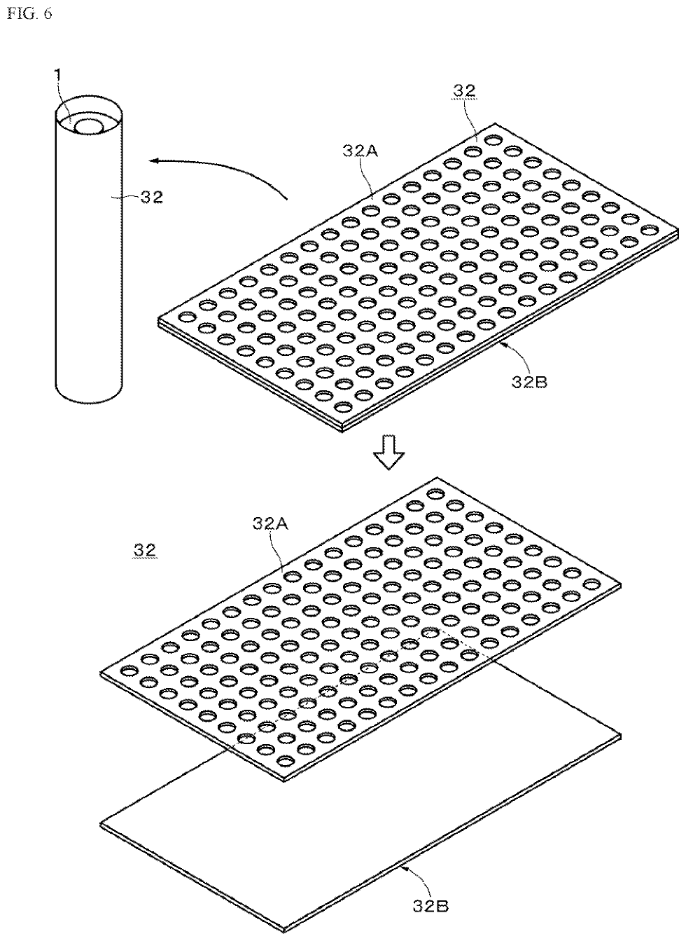

Next, another example of the insulating member (insulating member 32) will be described. As shown in FIG. 6, an insulating resin layer 32A having a large number of small openings, for example, circular holes, is used. A nonflammable gas generating member 32B is applied to the insulating resin layer 32A. That is, the insulating member 32 that insulates and covers the battery 1 is composed of two-layer films of the nonflammable gas generating member 32B that generates nonflammable gas at high temperature, as an interior, and the insulating resin layer 32A as an outer layer, and the insulating sheet 32A has a perforated shape.

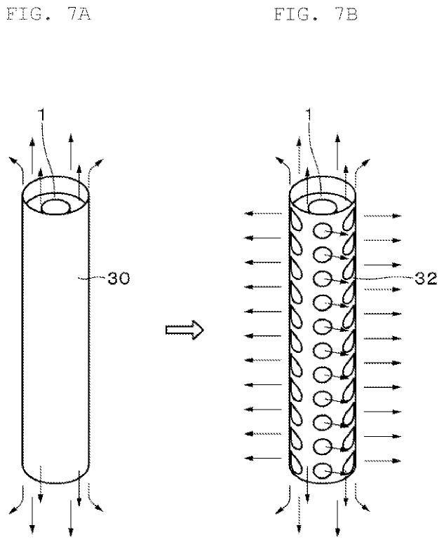

In the configuration of the insulating member 30 described above, as shown in FIG. 7A, the insulating resin layer 30A as the outer layer is a sealed sheet. Therefore, if nonflammable gas is generated from the nonflammable gas generating member 30B of the inner layer, the gas can only be released from the upper and lower openings. On the other hand, in the case of the insulating member 32, the insulating resin layer 32A of the outer layer has a perforated shape. Therefore, the nonflammable gas generating member 30B appears scattered on the surface of the insulating member 32. This allows nonflammable gas to be emitted in all directions through the upper and lower openings and the holes on the peripheral surface.

Therefore, when a plurality of the batteries 1 are housed in the case as a pack structure, nonflammable gas can be uniformly diffused in the case.

Next, a second embodiment of the present disclosure will be described. The second embodiment is a battery pack in which a plurality of the batteries are connected in series and/or in parallel, and housed together with a control circuit in an outer case. As an example, an example in which the present disclosure is applied to a battery pack having four batteries will be described.

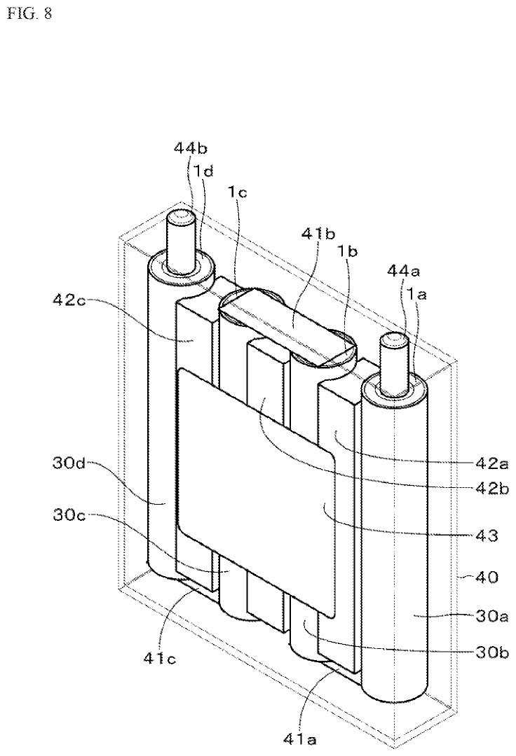

In FIG. 8, four batteries 1a, 1b, 1c, and 1d are housed side by side in an outer case 40 shown by the two-dot chain line. The batteries 1a to 1d are those in which the battery can 11 is covered with the insulating member 30, 31 or 32. In the example of FIG. 8, respective batteries are covered with the insulating members 30a, 30b, 30c, and 30d.

Inside the outer case 40, the positive and negative directions of adjacent batteries are reversed. Then, the batteries 1a and 1b are connected in series by an inter-cell connection tab 41a, the batteries 1b and 1c are connected in series by an inter-cell connection tab 41b, and the batteries 1c and 1d are connected in series by an inter-cell connection tab 41c. The method of connecting the plurality of the batteries is not limited to series connection, but may be parallel connection, or may be series-parallel connection.

Inter-cell foam holding members 42a, 42b, and 42c are interposed between adjacent batteries. That is, the inter-cell foam holding member 42a is interposed between the batteries 1a and 1b, the inter-cell foam holding member 42b is interposed between the batteries 1b and 1c, and the inter-cell foam holding member 42c is interposed between the batteries 1c and 1d.

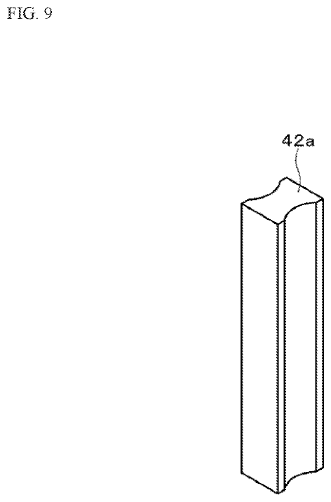

FIG. 9 is a perspective view of the inter-cell foam holding member 42a. The inter-cell foam holding member 42a has a prismatic shape and has a concave curved surface on the side surface that conforms to the peripheral surface of the battery. The other inter-cell foam holding members 42b, 42c, and 42d have the same shape as that of the inter-cell foam holding member 42a. As the inter-cell foam holding member 42a, for example, the followings can be used.

Polyurethane foam obtained by mixing and stirring polyol, polyisocyanate, and water to generate CO₂ and foam through the chemical reaction between water and isocyanate in urethane polymerization.

A foam molded by filling a mold with a resin foam bead raw material and foaming the material with high-temperature steam.

A foam molded by Mucell foam molding involving mixing N₂ and CO₂, which have been brought into a critical state at high pressure, with a raw material resin melted during resin molding, and foaming the mixture at the time of discharging at normal pressure in the mold.

Further, a foam is formed by mixing a nonflammable gas generating substance at the time of the molding.

Further, a printed circuit board 43, on which a circuit such as a protection circuit is mounted, is housed in the outer case 40. Then, external connection terminals 44a and 44b are derived from the outer case 40.

In the second embodiment of the present disclosure, when the internal volume of the pack is large, the amount of the nonflammable gas generating substance contained in the insulating member is not sufficient for reducing the oxygen concentration. Since the inter-cell foam holding members 42a, 42b, and 42c are interposed between the batteries, the following effects are obtained.

Firstly, the heat transfer from the battery that has generated heat at the time of abnormal heat generation can be shielded so as not to be transmitted to adjacent cells by the inter-cell foam holding members 42a to 42c as the heat insulating foam material provided between the cells.

Secondly, the surfaces of the inter-cell foam holding members 42a to 42c in contact with the battery that has generated heat are directly heated. Therefore, the nonflammable gas is supplemented and released into the pack, so that the nonflammable gas atmosphere is more effectively created.

As descried above, by inhibiting heat transfer to the adjacent cell and achieving reduction in the oxygen concentration in the atmosphere inside the pack, an induced explosion of the batteries in the pack can be prevented.

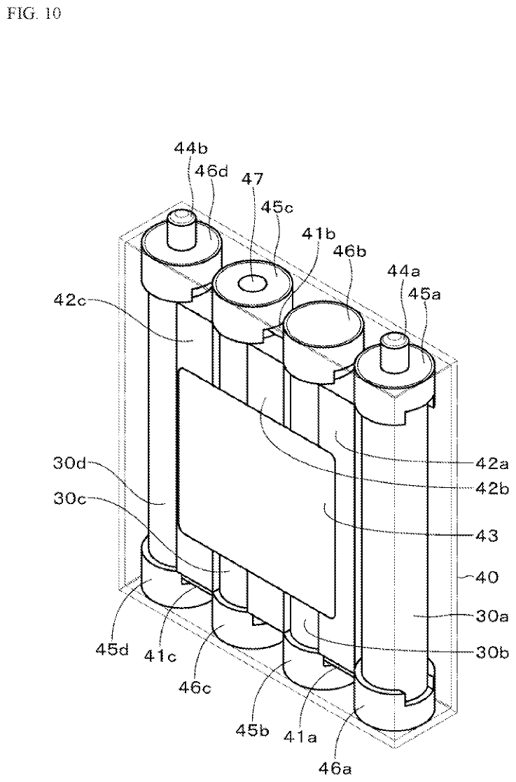

Next, a third embodiment of the present disclosure will be described with reference to FIG. 10. The third embodiment is a further improvement of the second embodiment. The components corresponding to the second embodiment are designated by the same reference numerals.

Four batteries are connected in series by the inter-cell connection tabs 41a, 41b and 41c. Further, respective batteries are those in which the battery can 11 is covered with the insulating member 30, 31 or 32. The inter-cell foam holding members 42a, 42b, and 42c, which are composed of foams that are thermally decomposed at high temperature to generate nonflammable gas, are interposed between adjacent batteries. Further, the printed circuit board 43 is housed in the outer case 40, and the external connection terminals 44a and 44b are derived from the outer case 40.

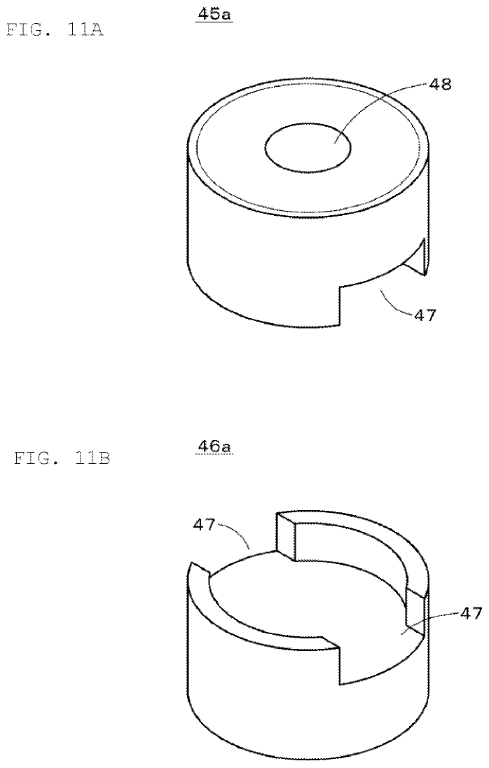

The upper ends of respective batteries on the safety valve side are covered with cap-shaped upper holding members 45a, 45b, 45c, and 45d. Further, the lower ends of respective batteries are covered with cap-shaped lower holding members 46a, 46b, 46c and 46d. These upper holding members 45a to 45d and lower holding members 46a to 46d are firmly connected and held to an exterior member 11 and the insulating member 30 of the battery. FIG. 11A is a perspective view showing the upper holding member 45a. The other upper holding members 45b, 45c, and 45d have the same shape as that of the upper holding member 45a. FIG. 11B is a perspective view showing the lower holding member 46a. The other lower holding members 46b, 46c, and 46d have the same shape as that of the lower holding member 46a.

The upper holding members 45a to 45d and the lower holding members 46a to 46d are made of a rigid material having a high thermal conductivity. Specifically, the upper holding members 45a to 45d and the lower holding members 46a to 46d are made of a material having high strength and high thermal conductivity (material having high thermal conductivity), such as carbon fiber-containing resin, phenolic resin, or metal. The thermal conductivity is preferably 3.0 to 200 W/m-K. Cutouts 47 for disposing inter-cell connection tabs are formed in the upper holding members 45a to 45d and the lower holding members 46a to 46d. Further, the upper holding members 45a to 45d each have a structure having a hole 48 for releasing flame, gas, or the like to the outside of the outer case 40.

In the third embodiment of the present disclosure, rigid holding members (upper holding members 45a to 45d and lower holding members 46a to 46d) having a high thermal conductivity are provided so as to hold the upper and lower ends of the plurality of the batteries housed in the outer case 40.

In the third embodiment, since the battery can be firmly held and fixed, a battery pack resistant to vibration, impact, and the like can be configured. Further, the heat conduction of the upper holding members 45a to 45d and the lower holding members 46a to 46d can effectively dissipate heat from the battery to the outside of the outer case 40. As a result, cooling during normal use and heat dissipation at the time of abnormal heat generation can be effectively carried out. Moreover, each of the upper holding members 45a to 45d is provided with the hole 48, whereby the high-temperature gas and flame ejected from the abnormal battery can be efficiently released to the outside of the outer case.

As described above, the third embodiment is a highly reliable battery pack that is resistant to mechanical loads such as vibration and drop impact in addition to battery cooling during normal use, and is also a safe battery pack that is highly reliable and does not induce an explosion during normal use by minimizing the influence of a battery that ignites at the time of abnormal heat generation.

The present disclosure is not limited to the above embodiments of the present disclosure, and various modifications and applications are possible without departing from the gist of the present disclosure. For example, the present disclosure can be applied not only to a cylindrical secondary battery but also to a laminated film type battery. The laminated film type battery has a wound electrode body housed inside the exterior member. The exterior member is a film-like member. The exterior member is, for example, a laminated film including a fusion-bondable layer, a metal layer, and a surface protective layer laminated in this order. For example, a two-layer film in which an insulating resin layer and a nonflammable gas generating member are laminated is used instead of the surface protective layer. Alternatively, the surface protective layer is covered with a two-layer film.

For example, the numerical values, structures, shapes, materials, raw materials, production processes, and the like exemplified in the above embodiments and examples are merely examples, and different numerical values, structures, shapes, materials, raw materials, and production processes, and the like may be used as necessary.

Hereinafter, application examples of the present disclosure will be described.

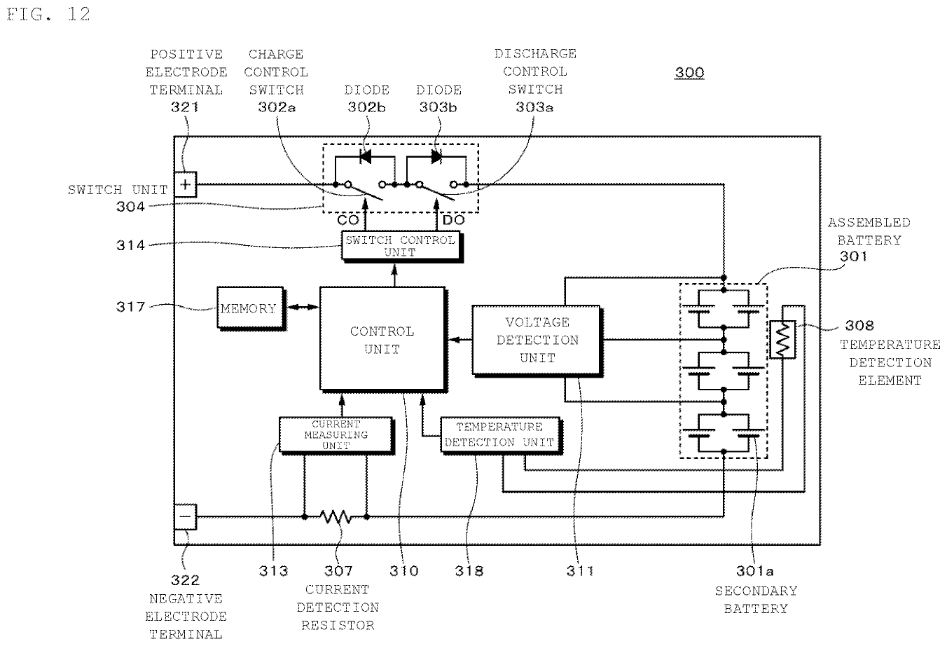

FIG. 12 is a block diagram showing a circuit configuration example when the battery according to an embodiment of the present disclosure (hereinafter, appropriately referred to as a secondary battery) is applied to a battery pack 330. The battery pack 300 includes an assembled battery 301, an exterior, a switch unit 304 including a charge control switch 302a and a discharge control switch 303a, a current detection resistor 307, a temperature detection element 308, and a control unit (controller) 310.

The battery pack 300 further includes a positive electrode terminal 321 and a negative electrode terminal 322. At the time of charging, the positive electrode terminal 321 and the negative electrode terminal 322 are connected to the positive electrode terminal and the negative electrode terminal of the battery charger, respectively, and charging is performed. When using an electronic device, the positive electrode terminal 321 and the negative electrode terminal 322 are connected to the positive electrode terminal and the negative electrode terminal of the electronic device, respectively, and discharging is performed.

The assembled battery 301 is formed by connecting a plurality of secondary batteries 301a in series and/or in parallel. This secondary battery 301a is the secondary battery of the present disclosure. In addition, in FIG. 12, the case where six secondary batteries 301a are connected in two parallels and three series (2P3S) is shown as an example, but in addition, any connection method may be used such as n parallel m series (n and m are integers).

The switch unit 304 includes the charge control switch 302a and a diode 302b, and the discharge control switch 303a and a diode 303b, and is controlled by the control unit 310. The diode 302b has a polarity that is in the reverse direction with respect to the charging current flowing from the positive electrode terminal 321 toward the assembled battery 301 and in the forward direction with respect to the discharging current flowing from the negative electrode terminal 322 toward the assembled battery 301. The diode 303b has a polarity that is in the forward direction with respect to the charging current and in the reverse direction with respect to the discharging current. In the example, the switch unit 304 is provided on the + side, but it may be provided on the − side.

The charge control switch 302a is turned off when the battery voltage reaches the overcharge detection voltage, and is controlled by the charge/discharge control unit so that the charging current does not flow in the current path of the assembled battery 301. After the charge control switch 302a is turned off, only discharging is possible via the diode 302b. Further, the charge control switch 302a is turned off when a large current flows during charging, and is controlled by the control unit 310 so as to shut off the charging current flowing in the current path of the assembled battery 301.

The discharge control switch 303a is turned off when the battery voltage reaches the overdischarge detection voltage, and is controlled by the control unit 310 so that the discharging current does not flow in the current path of the assembled battery 301. After the discharge control switch 303a is turned off, only charging is possible via the diode 303b. Further, the discharge control switch 303a is turned off when a large current flows during discharging, and is controlled by the control unit 310 so as to shut off the discharging current flowing in the current path of the assembled battery 301.

The temperature detection element 308 is, for example, a thermistor, which is provided in the vicinity of the assembled battery 301, measures the temperature of the assembled battery 301, and supplies the measured temperature to the control unit 310. A voltage detection unit 311 measures the voltage of the assembled battery 301 and each of the secondary batteries 301a constituting the assembled battery 301, A/D converts the measured voltage, and supplies the measured voltage to the control unit 310. A current measuring unit 313 measures the current using the current detection resistor 307, and supplies the measured current to the control unit 310.

The switch control unit 314 controls the charge control switch 302a and the discharge control switch 303a of the switch unit 304, based on the voltage and current input from the voltage detection unit 311 and the current measuring unit 313. The switch control unit 314 sends a control signal to the switch unit 304 when the voltage of any of the secondary batteries 301a becomes equal to or lower than the overcharge detection voltage or overdischarge detection voltage or when a large current suddenly flows, whereby overcharging, overdischarging, and overcurrent charging/discharging are prevented.

Here, for example, when the secondary battery is a lithium ion secondary battery, the overcharge detection voltage is defined as, for example, 4.20 V*0.05 V, and the overdischarge detection voltage is defined as, for example, 2.4 V*0.1 V.

As the charge/discharge switch, a semiconductor switch such as an MOSFET can be used. In this case, the parasitic diode of the MOSFET functions as the diodes 302b and 303b. When a P-channel FET is used as the charge/discharge switch, the switch control unit 314 supplies control signals DO and CO to the respective gates of the charge control switch 302a and the discharge control switch 303a, respectively. When the charge control switch 302a and the discharge control switch 303a are of the P channel type, they are turned on by the gate potential lower than the source potential by a predetermined value or more. That is, in normal charge and discharge operations, the control signals CO and DO are set to low levels, and the charge control switch 302a and the discharge control switch 303a are set to the ON state.

Then, for example, in the case of overcharging or overdischarging, the control signals CO and DO are set to high levels, and the charge control switch 302a and the discharge control switch 303a are set to the OFF state.

A memory 317 is composed of a RAM or a ROM, for example, EPROM (Erasable Programmable Read Only Memory) which is a non-volatile memory. In the memory 317, the numerical value calculated by the control unit 310, the internal resistance value of the battery in the initial state of each secondary battery 301a measured at the stage of the production process and the like are stored in advance, and can be rewritten as appropriate. Further, by storing the fully charged capacity of the secondary battery 301a, for example, the remaining capacity can be calculated together with the control unit 310.

The temperature detection unit 318 measures the temperature by using the temperature detection element 308, controls charging and discharging at the time of abnormal heat generation, and corrects the calculation of the remaining capacity.

The battery according to an embodiment of the present disclosure described above can be mounted on or used to supply power to devices such as an electronic device, an electric vehicle, an electric aircraft, and a power storage apparatus.

Examples of the electronic device include laptop computers, smart phones, tablet terminals, PDAs (personal digital assistants), mobile phones, wearable terminals, cordless phone handsets, video movies, digital still cameras, electronic books, electronic dictionaries, music players, radios, headphones, game machines, navigation systems, memory cards, pacemakers, hearing aids, electric tools, electric shavers, refrigerators, air conditioners, TVs, stereos, water heaters, microwave ovens, dishwashers, washing machines, dryers, lighting equipment, toys, medical devices, robots, road conditioners, and traffic lights.

Further, examples of the electric vehicle include a railway vehicle, a golf cart, an electric cart, and an electric car (including a hybrid vehicle). The battery of the present disclosure is used as a driving power source or an auxiliary power source of these electric vehicles.

Examples of the power storage apparatus include a power source for storing power in buildings such as houses or in power generation equipment.

Hereinafter, among the above application examples, specific examples of a power storage system using a power storage apparatus to which the battery of the present disclosure is applied will be described.

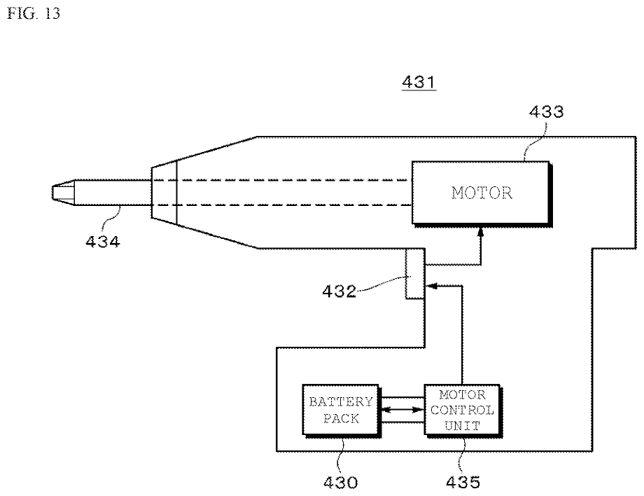

An example of an electric tool, for example, an electric screwdriver to which the present disclosure can be applied will be schematically described with reference to FIG. 13. In an electric screwdriver 431, a motor 433 such as a DC motor is housed inside the main body. The rotation of the motor 433 is transmitted to a shaft 434, and the shaft 434 drives a screw into the object. The electric screwdriver 431 is provided with a trigger switch 432 operated by the user.

A battery pack 430 and a motor control unit 435 are housed in the lower housing of the handle of the electric screwdriver 431. The battery pack 300 can be used as the battery pack 430. The motor control unit 435 controls the motor 433. Each part of the electric screwdriver 431 other than the motor 433 may be controlled by the motor control unit 435. Although not shown, the battery pack 430 and the electric screwdriver 431 are engaged with each other by an engaging member provided therein. As will be described later, a microcomputer is provided in each of the battery pack 430 and the motor control unit 435. A battery power source is supplied from the battery pack 430 to the motor control unit 435, and information on the battery pack 430 is communicated between the two microcomputers.

The battery pack 430 is detachable from, for example, the electric screwdriver 431. The battery pack 430 may be built in the electric screwdriver 431. The battery pack 430 is attached to the charging apparatus during charging. When the battery pack 430 is attached to the electric screwdriver 431, a part of the battery pack 430 may be exposed to the outside of the electric screwdriver 431 so that the exposed portion can be visually recognized by the user. For example, an LED may be provided on the exposed portion of the battery pack 430 so that the user can confirm whether the LED is emitted or turned off.

The motor control unit 435 controls, for example, the rotation/stop and the rotation direction of the motor 433.

Further, the motor control unit 435 shuts off the power supply to the load at the time of overdischarging. The trigger switch 432 is inserted between the motor 433 and the motor control unit 435, for example. When the user pushes the trigger switch 432, power is supplied to the motor 433 and the motor 433 rotates. When the user returns the trigger switch 432, the rotation of the motor 433 is stopped.

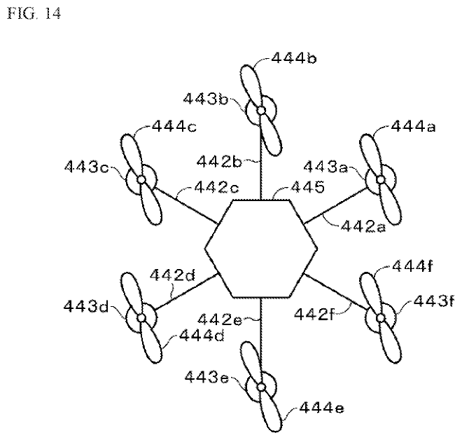

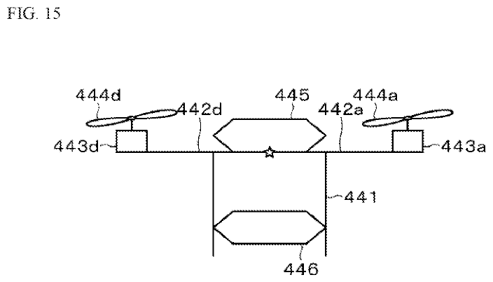

An example of applying the present disclosure to a power source for an electric aircraft will be described with reference to FIGS. 14 to 16. The present disclosure can be applied to the power source of an unmanned aircraft (so-called drone). FIG. 14 is a plan view of the unmanned aircraft, and FIG. 15 is a front view of the unmanned aircraft. The airframe is composed of a cylindrical or square tubular body part 441 as a central part, and support shafts 442a to 442f fixed to the upper part of the body part 441. As an example, the body part 441 has a hexagonal cylindrical shape, and six support shafts 442a to 442f extend radially from the center of the body part 441 at equal-angle intervals. The body part 441 and the support shafts 442a to 442f are made of a lightweight and high-strength material.

Further, in the airframe composed of the body part 441 and the support shafts 442a to 442f, the shape, arrangement, and the like of each component are designed so that the center of gravity of the airframe is on the vertical line passing through the center of the support shafts 442a to 442f. Further, a circuit unit 445 and a battery unit 446 are attached so that the center of gravity is on the vertical line.

Motors 443a to 443f as drive sources for rotor blades are attached to the tips of the support shafts 442a to 442f, respectively. Rotor blades 444a to 444f are attached to the rotation shafts of the motors 443a to 443f. The circuit unit 445 including a motor control circuit for controlling each motor is attached to the central part where the support shafts 442a to 442f intersect.

Further, the battery unit 446 as a power source is provided at a position below the body part 441. The battery unit 446 has three battery packs to supply power to a pair of the motor and the rotor blade with a space of 180 degrees. Each battery pack has, for example, a lithium ion secondary battery and a battery control circuit that controls charging and discharging. The battery pack 300 can be used as the battery pack. The motor 443a and the rotor blade 444a, and the motor 443d and the rotor blade 444d form a pair. Similarly, the motor 443b and the rotor blade 444b, and the motor 443e and the rotor blade 444e form a pair. The motor 443c and the rotor blade 444c, and the motor 443f and the rotor blade 444f form a pair. These pairs are equal in number to the battery pack.

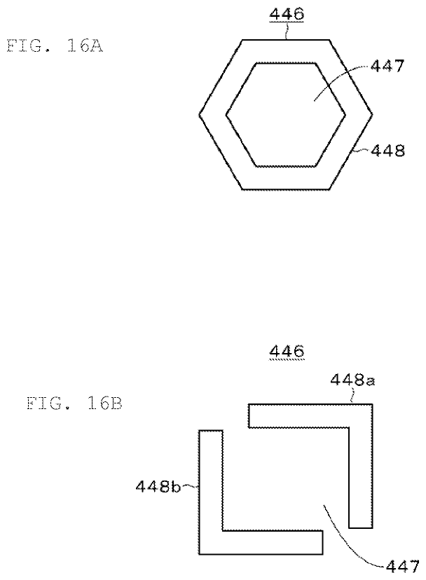

The battery unit 446 is detachably attached to, for example, the inside of the body part 441. As shown in FIG. 16, the battery unit 446 has a shape symmetrical with respect to the center, which is the position of the center of gravity of the airframe, and has an arrangement and an outer shape such as having a central opening 447. FIG. 16A is an example in which a hollow case 448 having a regular hexagonal shape around the central opening 447 in the plane view is provided, and the battery pack is housed in the case 448. As shown in FIG. 16B, the battery pack may be housed in separated cases 448a and 448b.

By matching the center of gravity of the battery unit 446 with the center of gravity of the airframe, the stability of the center of gravity is increased. Further, provision of the central opening 447 allows the wind to pass through the central opening 447 during flight, thereby enabling reduction in the influence of wind or the like. As a result, the attitude control becomes easy, the flight time can be lengthened, and the temperature rise of the battery can be suppressed.

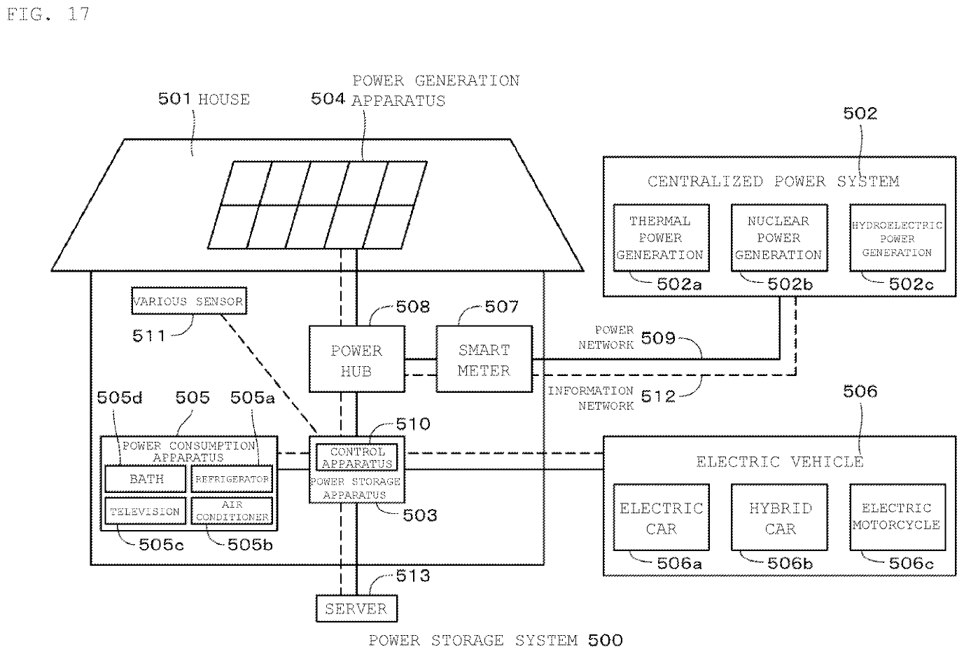

An example in which a power storage apparatus using the battery of the present disclosure is applied to a power storage system for a house will be described with reference to FIG. 17. For example, in a power storage system 500 for a house 501, power is supplied from a centralized power system 502 such as thermal power generation 502a, nuclear power generation 502b, and hydroelectric power generation 502c to a power storage apparatus 503 via a power network 509, an information network 512, a smart meter 507, a power hub 508, and the like. At the same time, power is supplied to the power storage apparatus 503 from an independent power source such as a power generation apparatus 504 in the home.

The power supplied to the power storage apparatus 503 is stored. The power storage apparatus 503 is used to supply the power used in the house 501. A similar power storage system can be used not only for the house 501 but also for buildings.

The house 501 is provided with the power generation apparatus 504, a power consumption apparatus 505, the power storage apparatus 503, a control apparatus (power information controller) 510 for controlling each apparatus, the smart meter 507, and a sensor 511 for acquiring various information. Each apparatus is connected by the power network 509 and the information network 512. A solar cell, a fuel cell, or the like is used as the power generation apparatus 504, and the generated power is supplied to the power consumption apparatus 505 and/or the power storage apparatus 503. The power consumption apparatus 505 includes a refrigerator 505a, an air conditioner 505b as an air conditioning apparatus, a television 505c as a television receiver, a bath 505d, and the like. Further, the power consumption apparatus 505 includes an electric vehicle 506. The electric vehicle 506 is an electric car 506a, a hybrid car 506b, and an electric motorcycle 506c.

The battery pack 300 of the present disclosure is applied to the power storage apparatus 503. The smart meter 507 has a function of measuring the commercial power consumption and transmitting the measured consumption to the electric power company. The power network 509 may be a combination of any one or a plurality of DC power supply, AC power supply, and non-contact power supply.

The various sensors 511 are, for example, a human sensor, an illuminance sensor, an object detection sensor, a power consumption sensor, a vibration sensor, a contact sensor, a temperature sensor, and an infrared sensor. The information acquired by the various sensors 511 is transmitted to the control apparatus 510. With the information from the sensor 511, the weather condition, the human condition, and the like can be grasped, and the power consumption apparatus 505 can be automatically controlled to minimize the energy consumption. Further, the control apparatus 510 can transmit information about the house 501 to the external electric power company or the like via the Internet.

The power hub 508 processes power line branching, DC/AC conversion, and so on. As the communication method of the information network 512 connected to the control apparatus 510, there is a method of using a communication interface such as UART (Universal Asynchronous Receiver-Transmitter) and a method of using a sensor network according to wireless communication standards such as Bluetooth (registered trademark), ZigBee, and Wi-Fi. The Bluetooth (registered trademark) system is applied to multimedia communication and is capable of one-to-many-connection communication. ZigBee uses the physical layer of IEEE (Institute of Electrical and Electronics Engineers) 802.15.4. IEEE802.15.4 is the name of a short-distance wireless network standard called PAN (Personal Area Network) or W (Wireless) PAN.

The control apparatus (power information controller) 510 is connected to an external server 513. The server 513 may be managed by any of the house 501, the electric power company, and the service provider. The information transmitted and received by the server 513 is, for example, power consumption information, life pattern information, electricity charges, weather information, natural disaster information, and information related to electricity transactions. The information may be transmitted and received from a power consumption apparatus in the home (for example, a television receiver), or may be transmitted and received from an apparatus outside the home (for example, a mobile phone). The information may be displayed on a device having a display function, for example, a television receiver, a mobile phone, or a PDA (Personal Digital Assistants).

The control apparatus (power information controller) 510 that controls each unit may include a CPU (Central Processing Unit), a processor, a RAM (Random Access Memory), a ROM (Read Only Memory), or the like, and is stored in the power storage apparatus 503 in this example. The control apparatus 510 is connected to the power storage apparatus 503, the power generation apparatus 504 in the home, the power consumption apparatus 505, various sensors 511, and the server 513 via the information network 512. The control apparatus 510 has a function of, for example, adjusting the commercial power consumption and the power generation. In addition, the control apparatus 510 may has a function of conducting power transactions in the power market.

As described above, the power storage apparatus 503 can store the power generated by not only the centralized power system 502 such as thermal power generation 502a, nuclear power generation 502b, and hydroelectric power generation 502c, but also the power generated by the power generation apparatus 504 in the home (solar power generation, wind power generation). Therefore, when the generated power of the power generation apparatus 504 in the home varies, it is possible to control the amount of power sent to the outside to be constant or to discharge as much as necessary. For example, the power obtained by solar power generation is stored in the power storage apparatus 503, the late-night power that is inexpensive at night is stored in the power storage apparatus 503, and the power stored by the power storage apparatus 503 is discharged during the time when the charge is high in the daytime.

In this example, although an example in which the control apparatus 510 is stored in the power storage apparatus 503 has been described, the control apparatus 510 may be stored in the smart meter 507 or may be configured independently. Further, the power storage system 500 may be used for a plurality of homes in an apartment house, or may be used for a plurality of detached houses.

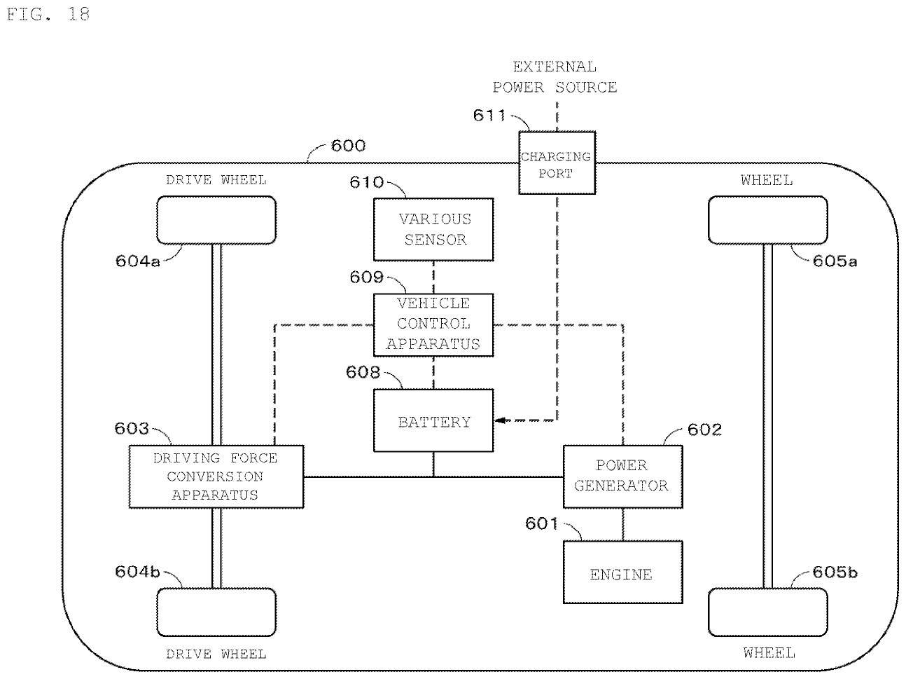

An example in which the present disclosure is applied to a power storage system for an electric vehicle will be described with reference to FIG. 18. FIG. 18 schematically shows an example of the configuration of a hybrid vehicle adopting the series hybrid system to which the present disclosure is applied. The series hybrid system is an automobile that runs by a power driving force conversion apparatus using the power generated by a power generator driven by an engine or the power temporarily stored in a battery.

In this hybrid vehicle 600, an engine 601, a power generator 602, a power driving force conversion apparatus (power driving force converter) 603, a drive wheel 604a, a drive wheel 604b, a wheel 605a, a wheel 605b, a battery 608, a vehicle control apparatus 609, various sensors 610, and a charging port 611 are mounted. The battery pack 300 of the present disclosure described above is applied to the battery 608.

The hybrid vehicle 600 runs by using the power driving force conversion apparatus 603 as a power source. An example of the power driving force conversion apparatus 603 is a motor. The power of the battery 608 operates the power driving force conversion apparatus 603, and the rotational force of the power driving force conversion apparatus 603 is transmitted to the drive wheels 604a and 604b. By using DC-AC conversion or reverse conversion (AC-DC conversion) where necessary, the power driving force conversion apparatus 603 can be applied to both AC motors and DC motors. The various sensors 610 control the engine speed via the vehicle control apparatus 609, and control the opening degree (throttle opening degree) of a throttle valve (not shown). The various sensors 610 include speed sensors, acceleration sensors, engine speed sensors, and the like.

The rotational force of the engine 601 is transmitted to the power generator 602, and the power generated by the rotational force in the power generator 602 can be stored in the battery 608.

When the hybrid vehicle 600 is decelerated by a braking mechanism (not shown), the resistance force at the time of deceleration is applied to the power driving force conversion apparatus 603 as a rotational force, and the regenerative power generated by this rotational force in the power driving force conversion apparatus 603 is accumulated in the battery 608.

The battery 608, when connected to an external power source of the hybrid vehicle 600, can receive power from the external power source by using the charging port 611 as an input port and store the received power.

Although not shown, an information processing apparatus (processor) that performs information processing related to vehicle control based on information related to the secondary battery may be provided. As such an information processing apparatus, for example, there is an information processing apparatus that displays the remaining battery level based on information about the remaining battery level.

In the above description, the series hybrid vehicle that runs by the motor using the power generated by the power generator operated by the engine or the power temporarily stored in the battery has been described as an example. However, the present disclosure is also effectively applicable to a parallel hybrid vehicle in which the outputs of the engine and the motor are used as drive sources, and the three methods of running only by the engine, running only by the motor, and running by the engine and the motor are appropriately switched and used. Further, the present disclosure can be effectively applied to a so-called electric vehicle that runs by being driven only by a drive motor without using an engine.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery comprising:
an electrode body; and
an exterior member that accommodates the electrode body,
wherein at least a part of the exterior member is covered with an insulating member, and the insulating member has a multi-layer structure,
wherein a side of the insulating member in contact with the exterior member is defined as an inner layer and a side of the insulating member opposite to the inner layer is defined as an outer layer, and
wherein an innermost layer of the insulating member includes a nonflammable gas generating member that generates nonflammable gas at high temperature, and an outermost layer of the insulating member includes an insulating resin layer.

2. The battery according to claim 1, wherein the insulating resin layer includes at least one of polyvinyl chloride, polyethylene terephthalate, polyolefin PTFE, or silicone.

3. The battery according to claim 1, wherein the nonflammable gas generating member includes at least one of a nonflammable gas generating substance or a binder.

4. The battery according to claim 3, wherein the binder includes at least one of polyester resin, polyolefin resin, epoxy resin, phenolic resin, polyvinyl alcohol, ethylene/vinyl acetate copolymer resin, polyvinylidene fluoride, acrylic, or polyurethane.

5. The battery according to claim 3, wherein the nonflammable gas generating substance includes at least one of melamine resin, nitrogen-containing phenolic resin, nitrogen-containing epoxy resin, sodium acetate, potassium acetate, sodium bicarbonate, magnesium bicarbonate, calcium bicarbonate, potassium bicarbonate, magnesium hydroxide, sodium hydroxide, or calcium hydroxide.

6. The battery according to claim 1, wherein the insulating member has a resin member including a material having a melting point higher than a melting point of the insulating resin layer and has a lattice shape between the nonflammable gas generating member and the insulating resin layer.

7. The battery according to claim 1, wherein the insulating member has at least one hole formed in the insulating resin layer.

8. A battery pack comprising:
a plurality of the batteries according to claim 1;
an outer case that accommodates the plurality of the batteries; and
an inter-cell holding member that holds the plurality of the batteries, wherein
the inter-cell holding member includes a foamed resin and a substance that generates nonflammable gas at a temperature.

9. The battery pack according to claim 8, comprising a holding member that holds each of the plurality of the batteries, wherein
the holding member is provided at each of an upper end and a lower end of each of the batteries, and
a through hole is provided in the holding member provided on a safety valve side of each of the batteries.

10. The battery pack according to claim 9, wherein the holding member includes a material having a high thermal conductivity.

11. An electronic device that receives power supplied from the battery according to claim 1.

12. An electric vehicle comprising:
the battery according to claim 1;
a conversion apparatus that receives power supplied from the battery and converts the power into a driving force of the electric vehicle; and
a processor configured to perform information processing related to vehicle control based on information related to the battery.

13. A power storage apparatus comprising the battery according to claim 1, wherein the power storage apparatus is configured to supply power to an electronic device connected to the battery.

14. The power storage apparatus according to claim 13, comprising a power information controller configured to transmit and receive a signal via a network with a device, wherein the power information controller configured to control charging and discharging of the battery based on received information.

15. A power system that receives power supplied from the battery according to claim 1.

16. The power system according to claim 15, wherein power is configured to be supplied to the battery from a power generation apparatus or a power network.
